(19) United States
(12) Patent Application Publication
(10) Pub. No.: US 2002/0144024 A1
(43) Pub. Date: Oct. 3, 2002

(54) Method and system for assigning peripheral devices to logical ports of a network peripheral server

(76) Inventors: David A. Kumpf, Rocklin, CA (US); Armando Guzman, Roseville, CA (US)

Correspondence Address: HEWLETT-PACKARD COMPANY, Intellectual Property Administration, P.O. Box 272400, Fort Collins, CO, 80527-2400, US

(21) Appl. No.: 09/822,619

(22) Filed: Mar. 30, 2001

(51) Int. Cl. B41J 1/00; B41B 1/00; G06K 1/00; B41F 1/00; G06F 15/00; G06F 3/00; G06F 15/16; G06F 15/173; G06F 13/20

(52) U.S. Cl. 710/12; 710/313; 709/203; 358/1.15

(57) ABSTRACT

A method and system for assigning logical port identification for multiple peripheral devices that may be connected to a peripheral server in a network environment is disclosed. The assigned logical port identification enables client computers to utilize client software to communicate with and control operation of the peripheral devices, even though the peripheral devices may be connected to the server with different types of physical interfaces, such as parallel port interfaces or by a Universal Serial Bus interface. The invention permits peripheral devices to be added and removed without producing peripheral device malfunctions and other problems that often occurred in the prior art.

The present invention relates to computer servers, and particularly to a system and method for connecting multiple peripheral devices to a peripheral server, principally in a network environment.

### BACKGROUND OF THE INVENTION

Peripheral server products, such as the Hewlett-Packard JetDirect EX, exist today that perform the function of connecting peripherals in a network environment, wherein the peripherals use a parallel port interface (IEEE 1284). For example, print servers provide a well-known and widely used network interface for network client computers to send print jobs to a printer connected with a parallel cable to a given port. In such devices, print jobs are routed to the printer connected to the given port, for example port 1, no matter what printer is currently connected there. Much software exists that uses this model, including software for driving print spoolers.

A problem can arise when a different printer is connected to the same port that may be a different type of printer having the different capabilities compared to the prior printer. Because the new printer necessarily receives any jobs send to that port, the job may not print correctly. This problem becomes particularly acute when the server and peripherals use the USB (Universal Serial Bus) interface. With the USB interface, all peripherals on the bus are assigned addresses randomly every time they are turned on. Thus, it becomes possible for two peripherals to exchange addresses even when neither has been disconnected. Also, typical USB servers have just one port and use intermediate hubs to connect multiple peripherals.

The different ports that client software communicates with can be thought of as “logical ports”. The physical connectors that the cables from the peripherals connect to can be thought of as “physical ports”. In existing parallel interface peripheral servers, even though there is a one-to-one correspondence between a logical port and a physical port, problems can occur as previously described. Furthermore, proper communication fails completely with USB when there are multiple peripherals connected to a single physical port.

While some of the problems may be alleviated by having the client software use a unique name for each printer instead of a logical port number, with the name being provided by the peripheral so it was the same, no matter where the peripheral was connected, the disadvantages of this solution include incompatibility with existing client software and the fact that many peripherals do not supply such a name.

Another alternative is for a USB server to have multiple physical ports, which then could be numbered sequentially and mapped one-to-one to logical ports. However, this solution does not solve the problem with moving printers and it requires a USB host controller for each physical port, which increases the cost of the product. Another alternative for USB devices is to use their USB address as their physical port number, which would again allow them to be numbered sequentially and mapped to logical ports. The disadvantage of this solution is that it also does not solve the problems with moving printers and randomly assigned USB addresses.

### BRIEF SUMMARY OF THE INVENTION

The present invention is directed to a system and method that, among other things, directs communications from client computers to peripheral devices using the same sequentially numbered logical ports (port 1, port 2, etc.) that client software expects to talk to, and assigns the same peripherals to the same logical ports every time they are turned on. This is done substantially regardless of the type of physical port interface that is being used to interconnect a peripheral server to the peripheral device.

The system and method, in its preferred embodiment, has a peripheral server that automatically queries peripheral devices that are connected to a network for identification information that is sent back and used by the server to assign a logical port identification to respective peripheral devices. The identification information of the peripheral devices, as well as the logical port identification and status of the logical port is maintained in a table that has a predetermined maximum number of logical ports.

The system assigns logical ports that are free, and places peripheral devices that have no logical port assigned in a queue until a logical port becomes free or a reserved logical port is reassigned, according to specified criteria. The system can operate automatically or in a manual assignment mode.

### DESCRIPTION OF THE DRAWINGS

FIG. 1 is block diagram of a network having a peripheral server and client computers connected thereto, and having peripheral devices connected to the server using parallel as well as USB connections, with the latter being made through a USB hub.

FIG. 2 is a logical port table having representative entries and status.

FIG. 3 is a flow chart of the operation of a preferred embodiment wherein a new peripheral device is connected to the server.

FIG. 4 is a flow chart of the operation of a preferred embodiment after a newly connected peripheral has been placed in a queue because of the unavailability of a logical port.

### DETAILED DESCRIPTION

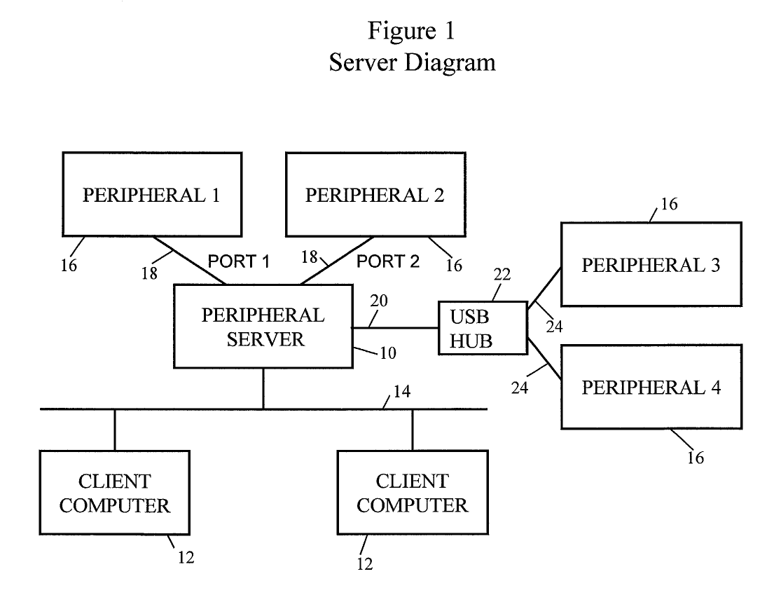

In many network environments, and referring to the block diagram of FIG. 1, a peripheral server 10 provides a well-known and widely used network interface for network client computers 12 to send peripheral function tasks via a network 14, such as print jobs, to a peripheral device 16 connected with a parallel cable 18 to a given port. In such devices, print jobs are routed to the printer connected to the given port, for example port 1, no matter what printer is currently connected there. The network environment may also include USB connected peripheral devices, which may be implemented by a port 20 connected to a USB hub 22 to which additional peripheral devices may be connected by USB cables 24.

In accordance with a preferred embodiment of the present invention, a system and method involves assigning logical ports for communicating with peripheral devices 16, regardless of the type of physical port interfaces that physically interconnect the peripheral device to the server 10. The system and method is adapted to be used with multiple peripheral devices being connected to a single server, but the actual number of possible logical port interfaces is preferably maintained at a maximum number that is likely to take care of the vast majority of installations. In this regard, it is believed that 4 logical port entries is a reasonable number, although a larger number can certainly be used.

The system and method of the present invention is adapted for USB peripherals, parallel (IEEE 1284) peripherals, and all other known commercially available peripheral interfaces. A significant advantage of the present invention is that the operation of the peripheral devices by the client computer can be carried out without requiring any changes to the client software that is resident in the client computer.

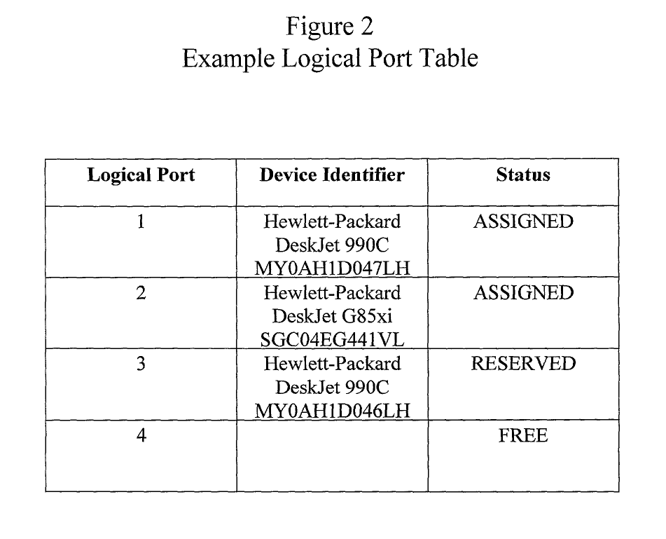

In accordance with a preferred embodiment of the present invention, when the network peripheral server (e.g., a Hewlett-Packard JetDirect EX) is first initialized, it creates a table of the type shown in FIG. 2 that maps peripheral devices to logical port numbers. This table consists of a number of entries, i.e., preferably 4 as previously described, with each entry having at least the following information: logical port number, device identification, and current status.

The table is stored in some form of non-volatile memory, preferably in the server, so that previously mapped device information is available to the server every time it reinitializes. Referring to the table in FIG. 2, examples of data are illustrated as shown, including the logical port number, which is a number from one to the number of ports supported, e.g., four. The device identification information in each entry preferably uniquely identifies an individual device. In the preferred embodiment, the information includes the device's manufacturer, model name, and a unique serial number. It should be understood that additional or different information may be used. The current status reflects whether this logical port is currently unused (FREE), has an attached peripheral device currently assigned to it (ASSIGNED), or had a device assigned to a logical port in the past that is not currently attached (RESERVED).

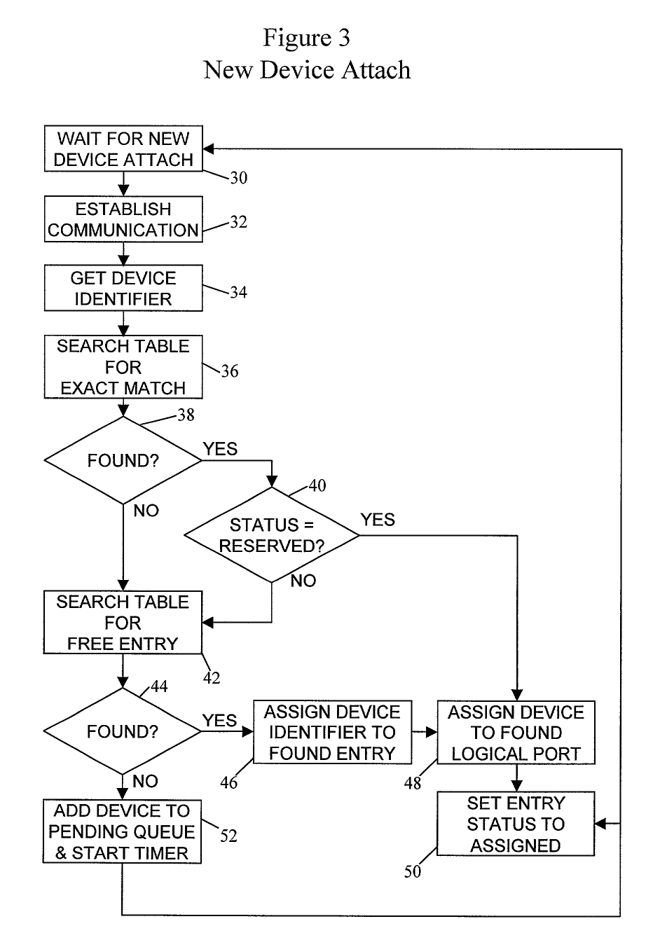

If a new peripheral device is attached after the server was initialized, the preferred embodiment of the system and method carries out the process shown in the flow chart of FIG. 3. After detection of the attachment (block 30), the server first establishes communications with the device using well understood protocols such as USB, IEEE-1284, etc. (block 32). Next, the server requests device identification information (block 34). For USB devices, it issues standard USB requests for the manufacturer, model, and serial number. For IEEE-1284 devices, it issues a standard request for the device-id string, perhaps followed by vendor specific requests such as HP PML (Printer Management Language) GET requests. The server combines all the device information to form an identification key.

Next the server searches the table of previously assigned devices for a matching key (block 36, 38). If an exact match is found, the server checks to determine if the current status on that logical port is RESERVED (block 40). If RESERVED, it indicates that it may have been the exact device that was previously connected or a peripheral device that has the same capabilities as the previously assigned device and should therefore be compatible, and the server assigns the device to the found logical port (block 48). If the table entry indicates that the device is not RESERVED, then it must be ASSIGNED, meaning there is a device with the same key already connected, enabled and assigned to this logical port. In that unlikely event, the server searches the table for a FREE entry (block 42) and if one is found (block 44), the server assigns the device's key to the device identifier field (which was previously empty) in the table entry for the selected logical port (block 46) and this peripheral device is then assigned to the found logical port and the logical port activated so that client software can communicate with the peripheral device (block 48). The status field of that logical port entry in the table is then set to ASSIGNED (block 50), and the server returns to waiting for new devices (block 30).

If there are no FREE entries, the server suspends processing this device for some period to allow other devices that might just be initializing a chance to be assigned to their RESERVED entries. This situation can arise, for example, when a cluster of devices is powered on at the same time. The server adds the new device to a queue of pending devices, starts a timer (block 52), and returns to waiting for new devices (block 30). The timer interval should be sufficient to allow other devices to complete their initialization and establish communications with the server. For printer and multifunction peripheral (MFP) devices, a good value is approximately two minutes, although a greater or lesser value may be used.

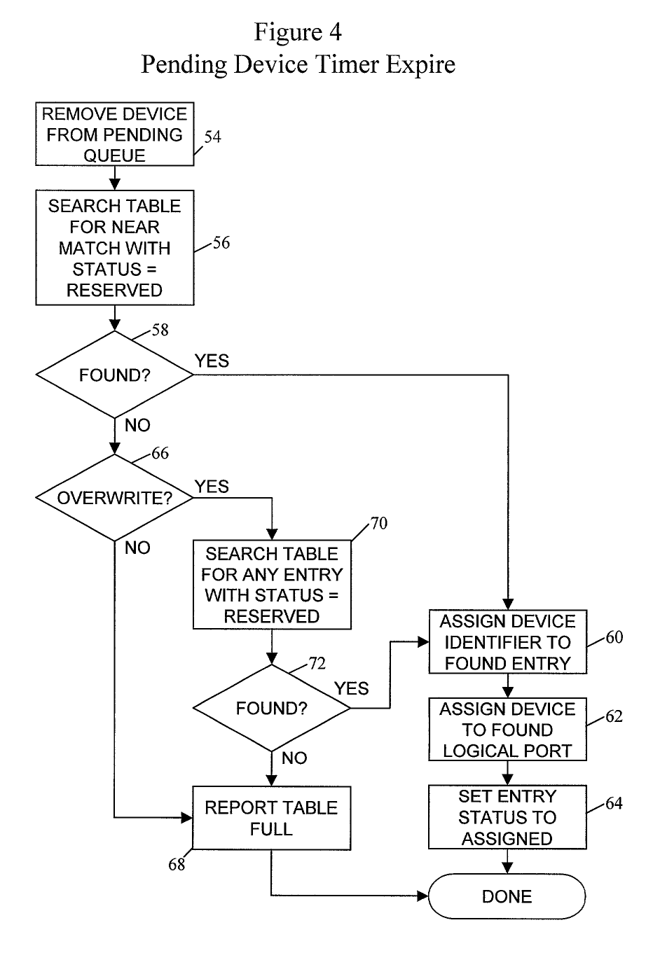

In accordance with the preferred embodiment of the present invention, and referring to FIG. 4, when the timer expires, the server removes the new device from the pending queue and continues processing it (block 54). The server searches the table for a RESERVED entry that provides a near match for the new peripheral device (block 56). If multiple entries are found (block 58), the server picks the one that is the closest match for the new device identification or key according to specified criteria by assigning the device identifier to the found entry (block 60), assigns the assigned device to the found logical port (block 62) and sets the status of it to ASSIGNED (block 64). For example, an entry having the same manufacturer and model, but which differs only in the serial number may be determined to be a closest match. There are also many other criteria that could also be used to determine a closest match and can result in a very complex implementation. The server may have a database containing information on many peripheral devices, and may examine the database for other matching or similar criteria, including similar functioning model numbers, for example. After the server replaces the key with the new one and sets the current status to ASSIGNED, it returns to waiting for new devices (block 30).

If there are no RESERVED entries in the table (block 58), the server is at capacity. It logs the fact that the new device could not be added and therefore there is no overwrite (block 66), reports that the table is full (block 68) and returns to waiting for new devices. However, the system may permit a manual or automatic overwrite function to be carried out if it is desired. If an overwrite is to be done, the server searches the table for any entry with a RESERVED status (block 70), which if found (block 72) results in the assigning of the device identifier to the found entry (block 60) and the subsequent steps 62 and 64. If there were no RESERVED status entries found (block 72), the server report the table as being full.

During operation it is preferred that if a device is disconnected, the server will detect that condition and will locate the table entry for that device, set its current status to RESERVED, then return to waiting for new devices.

While the foregoing description covers the preferred embodiment which automatically assigns logical port. An alternative embodiment permits manual options to be available for users who prefer them. As noted in the background of the invention, existing servers that support IEEE-1284 parallel port devices automatically assign devices to logical ports based strictly on what parallel port they are connected to. For users or network administrators that wish to preserve this behavior, the server can offer an option to disable the new process and use the old one instead. As described above with respect to the preferred embodiment, the server assigns new devices to any free port and then re-assigns them to that same port every time they are reinitialized. Some users or network administrators may wish to manually assign new devices to a logical port of their choosing. In that case, the process described above can be replaced by one that puts all new devices in a pending queue. A user or network administrator can then assign devices via a user interface that presented a list of pending devices and a list of free ports. When the user selected a device and port combination, the server then assigns the device to that logical port, stores the key in that table entry, and sets the current status to ASSIGNED.

From the foregoing, it should be appreciated that a system and method of assigning logical port numbers to peripheral devices that provides greater convenience and reliability in the operation of peripheral devices in a network environment where the peripheral devices may be physically connected to a peripheral server by a number of different physical port interfaces. The system is adapted to automatically assign logical port numbers and also reassign them as necessary in accordance with specified criteria. The system and method can be easily implemented at a relatively low cost.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method of assigning logical ports to respective peripheral devices physically connected to a server in a network having client computers with client software, wherein the respective peripheral devices are connected to one or more physical port interfaces, the assigned logical ports enabling client software to communicate with the peripheral devices regardless of the particular physical port interface the peripheral device is connected to, the method comprising the steps of:
the server querying, responsive to a predetermined event, a peripheral device that is connected to the server by a physical port interface for information which identifies the peripheral device;
the peripheral device communicating said identification information to the server;
the server initially assigning a logical port identification for a peripheral device that is connected to a physical port interface of the server and storing said logical port identification and said identification information in memory;
the server thereafter directing communications for respective peripheral devices from client computers to said assigned logical port for such peripheral devices, wherein the communications are executed utilizing the client software.

2. A method as defined in claim 1 wherein the peripheral devices are connected to the server via a physical parallel port interface.

3. A method as defined in claim 1 wherein the peripheral devices are connected to the server via a physical Universal Serial Bus interface.

4. A method as defined in claim 1 wherein said predetermined event is the initialization of the server.

5. A method as defined in claim 1 wherein said predetermined event is the connection of a previously unconnected peripheral device to the server.

6. A method as defined in claim 1 wherein said peripheral device identification information comprises one or more of the manufacturer, model name, model number and serial number of the peripheral device.

7. A method as defined in claim 1 wherein said logical port identification and said identification information are stored in a table having a predetermined maximum number of logical port entries.

8. A method as defined in claim 7 wherein the status of each of said maximum logical port entries is maintained in said table, with logical ports that are assigned having an assigned status and logical ports that are unassigned having a free status.

9. A method as defined in claim 8 wherein when the server, responsive to said predetermined event, queries peripheral devices that are then connected to the server, compares said identification information received therefrom with said information maintained in said table and utilizes said assigned logical ports for directing communications to the connected peripheral devices in response to a positive comparison.

10. A method as defined in claim 8 wherein when the server, responsive to said predetermined event, queries peripheral devices that are then connected to the server, compares said identification information received therefrom with said information maintained in said table and fails to detect a positive comparison, performs the following steps with respect to each peripheral device for which a positive comparison is not found:
the server searches the table to determine if the number of logical port entries is less than the maximum number of entries, indicating that one or more logical port entries are available;
the server assigns an available logical port identification to an unassigned peripheral device and stores said logical port identification, said identification information and an assigned status in an entry in the table in response to a logical port being available;
the server suspends processing of the unassigned peripheral device for a predetermined time period if there is no logical port available;
the server resumes processing after said predetermined time period and searches said table for reserved status entries and selects a reserved entry that closely matches, according to predetermined criteria, the identification information of the peripheral device that is unassigned and assigns the unassigned peripheral device to the logical port.

11. A method as defined in claim 10 wherein unassigned peripheral devices are placed in a queue for subsequent processing.

12. A method as defined in claim 1 wherein said memory is a non-volatile memory.

13. A method of assigning logical ports to respective peripheral devices physically connected to a server in a network having client computers with client software, wherein the respective peripheral devices are adapted to be connected to one or more physical port interfaces, the assigned logical ports enabling client software to communicate with the peripheral devices regardless of the particular physical port interface the peripheral device is connected to, the method comprising the steps of:
the server querying, responsive to a predetermined event, a peripheral device that is connected to the server by a physical port interface for information which identifies the peripheral device;
the peripheral device communicating said identification information to the server;
the server placing the unassigned peripheral devices in a queue for subsequent assignment of logical ports by manual assignment;
the server storing assigned logical port identification and said identification information in memory;
the server thereafter directing communications for respective peripheral devices from client computers to said assigned logical port for such peripheral devices wherein said communications are executed utilizing the client software.

14. A method as defined in claim 13 wherein said logical port identification and said identification information are stored in a table having a predetermined maximum number of logical port entries, said logical ports that are assigned having an assigned status and logical ports that are unassigned having a free status.

15. A system of assigning logical ports to respective peripheral devices physically connected to a server connected in a network including client computers having client software for controlling the operation of the peripheral devices, wherein the respective peripheral devices are connected to one or more physical port interfaces, the assigned logical ports enabling client software to communicate with the peripheral devices regardless of the particular physical port interface the peripheral device is connected to, the system comprising:
the server being adapted to query, responsive to a predetermined event, a peripheral device that is connected to the server by a physical port interface for information which identifies the peripheral device;
the peripheral device being adapted to communicate said identification information to the server;
the server being adapted to initially assign a logical port identification for a peripheral device that is connected to a physical port interface of the server and store said logical port identification and said identification information in memory;
the server thereafter directing communications for respective peripheral devices from client computers to said assigned logical port for such peripheral devices, wherein the client computers communicate with the peripheral device using the client software.

16. A system as defined in claim 15 wherein the server stores logical port identification and said identification information in a table having a predetermined maximum number of logical port entries.

17. A system as defined in claim 16 wherein the server stores the status of each of said maximum logical port entries in said table, with logical ports that are assigned having an assigned status and logical ports that are unassigned having a free status.

18. A system as defined in claim 17 wherein when the server, responsive to said predetermined event, queries peripheral devices that are then connected to the server, compares said identification information received therefrom with said information maintained in said table and directs communications to the connected peripheral devices using said assigned logical ports in response to a positive comparison.

19. A system as defined in claim 18 wherein when the server, responsive to said predetermined event, queries peripheral devices that are then connected to the server, compares said identification information received therefrom with said information maintained in said table and fails to detect a positive comparison, the server performs the following steps with respect to each peripheral device for which a positive comparison is not found:
the server searches the table to determine if the number of logical port entries is less than the maximum number of entries, indicating that one or more logical port entries are available;
the server assigns an available logical port identification to an unassigned peripheral device and stores said logical port identification, said identification information and an assigned status in an entry in the table in response to a logical port being available;
the server suspends processing of the unassigned peripheral device for a predetermined time period if there is no logical port available;
the server resumes processing after said predetermined time period and searches said table for reserved status entries and selects a reserved entry that closely matches, according to predetermined criteria, the identification information of the peripheral device that is unassigned and assigns the unassigned peripheral device to the logical port.

20. A computer program product comprising a computer usable medium having computer readable program codes embodied in the medium that when executed causes the server to:
query a peripheral device that is connected to the server by a physical port interface for information which identifies the peripheral device, responsive to a predetermined event;
receive identification information that is transmitted by the peripheral device;
assign a logical port identification for the peripheral device that transmitted the identification information and store said logical port identification and said identification information in memory;
thereafter direct communications for the peripheral device from client computers to said assigned logical port for such peripheral devices, wherein the communications are executed utilizing the client software.

21. A product as defined in claim 20 which causes the server to store the status of each of said logical port entries in said table, with logical ports that are assigned having an assigned status and logical ports that are unassigned having a free status.

22. A product as defined in claim 21 which causes the server, when responsive to said predetermined event, to query peripheral devices that are then connected to the server, to compare said identification information received therefrom with said information maintained in said table and direct communications to the connected peripheral devices using said assigned logical ports in response to a positive comparison.

23. A product as defined in claim 22 which causes the server, when responsive to said predetermined event, to query peripheral devices that are then connected to the server, to compares said identification information received therefrom with said information maintained in said table and fails to detect a positive comparison, perform the following steps with respect to each peripheral device for which a positive comparison is not found:
search the table to determine if the number of logical port entries is less than a maximum number of entries, indicating that one or more logical port entries are available;
assign an available logical port identification to an unassigned peripheral device and store said logical port identification, said identification information and an assigned status in an entry in the table in response to a logical port being available;
suspend processing of the unassigned peripheral device for a predetermined time period if there is no logical port available;
resume processing after said predetermined time period and search said table for reserved status entries and select a reserved entry that closely matches, according to predetermined criteria, the identification information of the peripheral device that is unassigned and assign the unassigned peripheral device to the logical port.

24. A product as defined in claim 23 where said identification of information that approximates said identification information comprises at least identical manufacturer and model information.
